(19) United States
(12) Patent Application Publication
(10) Pub. No.: US 2017/0204006 A1
(43) Pub. Date: Jul. 20, 2017

(54) OPTICAL ELEMENT MANUFACTURING METHOD

(71) Applicant: Olympus Corporation, Tokyo (JP)

(72) Inventor: Jun Ichinose, Tokyo (JP)

(21) Appl. No.: 15/475,564

(22) Filed: Mar. 31, 2017

Related U.S. Application Data
(63) Continuation of application No. PCT/JP2014/076796, filed on Oct. 7, 2014.

(51) Int. Cl. C03C 23/00; B23K 26/00; C03B 11/05

(52) U.S. Cl. CPC C03C 23/0025; C03B 11/05; B23K 26/0057; G02B 27/0018

(57) ABSTRACT

An optical element manufacturing method includes: heating and softening a molding material so as to mold an optical element; and creating a scattering region outside an effective diameter of the optical element while substantially maintaining an outside dimension of the optical element formed in molding, wherein, in the creating, the scattering region is created in a region outside the effective diameter of the optical element by irradiating the region outside the effective diameter of the optical element with a laser and forming a crack or an altered layer.

### CROSS REFERENCE TO RELATED APPLICATIONS

This is a continuation application of PCT application No. PCT/JP/2014/076796, filed on Oct. 7, 2014, which was not published under PCT Article 21(2) in English.

### BACKGROUND OF THE INVENTION

Field of the Invention

The present invention relates to an optical element manufacturing method for manufacturing an optical element.

Description of the Related Art

Conventionally, a technique is used for forming an outer peripheral surface of a lens so as to be a rough surface by performing outer diameter centering by grinding. According to this technique, when a portion of light incident on the lens becomes stray light, and the stray light is projected onto the outer peripheral surface, irregular reflection on the rough surface prevents ghosts or flares.

FIG. 6A is a sectional view illustrating a lens 200 for which an outer peripheral surface is a ground surface 200a.

FIG. 6B is a sectional view illustrating a lens 300 for which an outer peripheral surface is a mirror surface 300a.

In a case in which the outer peripheral surface of the lens 200 is the ground surface 200a, as illustrated in FIG. 6A, stray light L10 is scattered on the ground surface 200a due to irregular reflection (scattered light L11, L12, or L13). Accordingly, ghosts or flares can be prevented.

On the other hand, in a case in which the outer peripheral surface of the lens 300 is the mirror surface 300a, as illustrated in FIG. 6B, stray light L20 is reflected by the mirror surface 300a (reflected light L21). Accordingly, the reflected light L21 generates ghosts or flares.

From the viewpoint of preventing ghosts or flares, it is preferable that the outer peripheral surface of a lens be a rough surface such as the ground surface 200a illustrated in FIG. 6A. However, in recent years, it has been requested to improve the accuracy of a lens outer diameter, and a problem arises wherein costs drastically increase when a highly accurate outer diameter is formed by grinding.

On the other hand, when a highly accurate outer diameter is formed by heating and softening a molding material so as to mold an optical element, the accuracy of an outer diameter regulating member is transferred with no change, and therefore mass-production at a low cost can be achieved. In addition, an optical element having an uneven outer peripheral surface can be molded by forming unevenness on the outer diameter regulating member (see, for example, Japanese Laid-Open Patent Publication No. 2000-203852).

In addition, a technique is known for forming a stray light suppression region colored in gray by irradiating the outside of an effective diameter of an optical element with ultraviolet rays (see, for example, Japanese Laid-Open Patent Publication No. 2007-163551).

In a marking method for applying a marking to a light-transmissive material, a technique is known for applying a marking to the inside of the light-transmissive material by using a laser beam (see, for example, Japanese Patent No. 3208730).

### SUMMARY OF THE INVENTION

An optical element manufacturing method includes: heating and softening a molding material so as to mold an optical element; and creating a scattering region outside an effective diameter of the optical element while substantially maintaining an outside dimension of the optical element formed in molding, wherein, in the creating, the scattering region is created in a region outside the effective diameter of the optical element by irradiating the region outside the effective diameter of the optical element with a laser and forming a crack or an altered layer.

### BRIEF DESCRIPTION OF THE DRAWINGS

FIG. 1 is a sectional view illustrating a molding state of an optical element according to a first embodiment of the present invention.

FIG. 2A is a front view explaining a creation of a scattering region according to the first embodiment of the present invention.

FIG. 2B is a right-hand side view explaining a creation of a scattering region according to the first embodiment of the present invention.

FIG. 3A is a front view explaining a creation of a scattering region according to a second embodiment of the present invention.

FIG. 3B is a right-hand side view explaining a creation of a scattering region according to the second embodiment of the present invention.

FIG. 4A is a front view explaining a creation of a scattering region according to a third embodiment of the present invention.

FIG. 4B is a right-hand side view explaining a creation of a scattering region according to the third embodiment of the present invention.

FIG. 5A is a front view explaining a creation of a scattering region according a fourth embodiment of the present invention.

FIG. 5B is a right-hand side view explaining a creation of a scattering region according to the fourth embodiment of the present invention.

FIG. 6A is a sectional view illustrating a lens for which an outer peripheral surface is a ground surface.

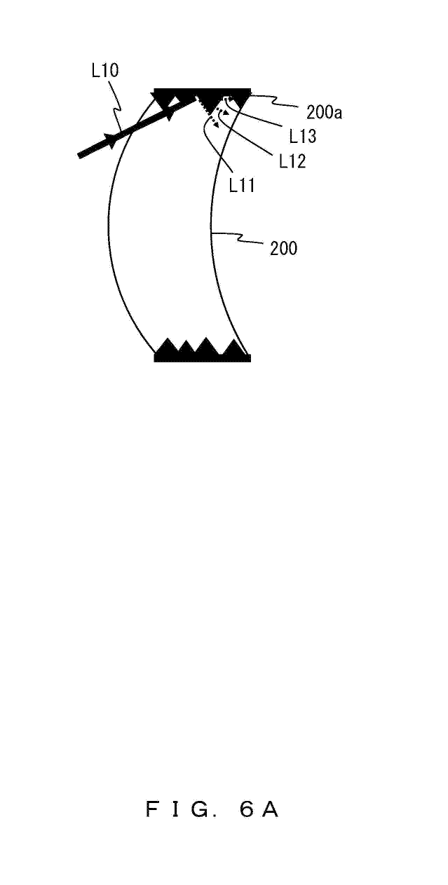

FIG. 6B is a sectional view illustrating a lens for which an outer peripheral surface is a mirror surface.

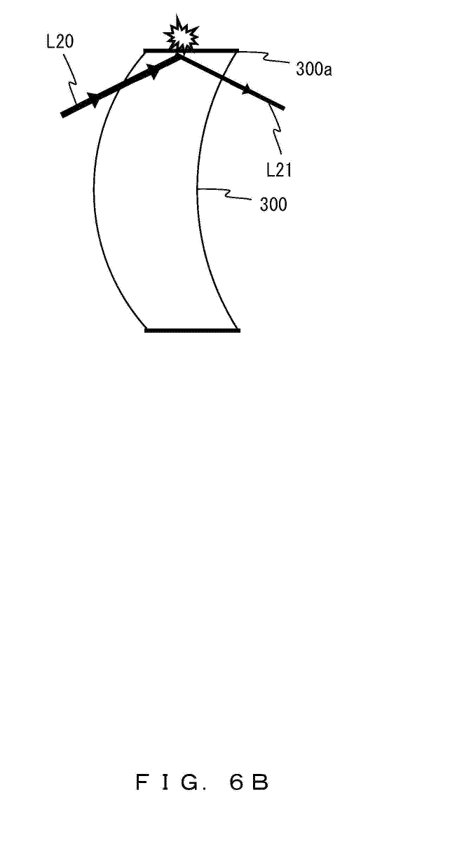

### DESCRIPTION OF THE PREFERRED EMBODIMENT

In a technique for forming an uneven outer peripheral surface in an optical element by using an outer diameter regulating member, as described above, an uneven outer peripheral surface including a free surface due to molding is formed, and therefore stray light cannot be scattered sufficiently, and harmful effects due to the stray light, such as ghosts or flares, cannot be reliably prevented. In addition, unevenness of the outer peripheral surface causes a problem wherein an outer diameter cannot be formed with a high accuracy, or a problem wherein a molded optical element cannot be drawn out of the an outer diameter regulating member when the uneven outer peripheral surface has an unevenness that is greater than or equal to a difference in linear expansion between the optical element and the outer diameter regulation member.

In addition, in a technique for forming a stray light suppression region colored in gray, as described above, it takes a long time to form the stray light suppression region, or it is difficult to sufficiently color the stray light suppression region depending on the material of an optical element. Further, stray light cannot be scattered, and therefore harmful effects due to the stray light cannot be reliably prevented.

An outer diameter can be formed with a high accuracy at a low cost by maintaining an outer peripheral surface of an optical element in the state of a mirror surface after molding without performing grinding or the like on the outer peripheral surface. However, countermeasures, such as applying a paint including an additive on the outer peripheral surface, need to be taken in order to prevent harmful effects due to stray light, and, as an example, a variation in a film thickness of the paint results in deterioration in the accuracy of the outer diameter.

The problems above in the conventional technology do not arise only in a lens, but also arise in another optical element such as a prism. The accuracy of the outer diameter has been described above, but it is requested similarly that another outside dimension, such as the length or width of one side in the case of an optical element having a polygonal cylindrical shape, be formed with a high accuracy.

### First Embodiment

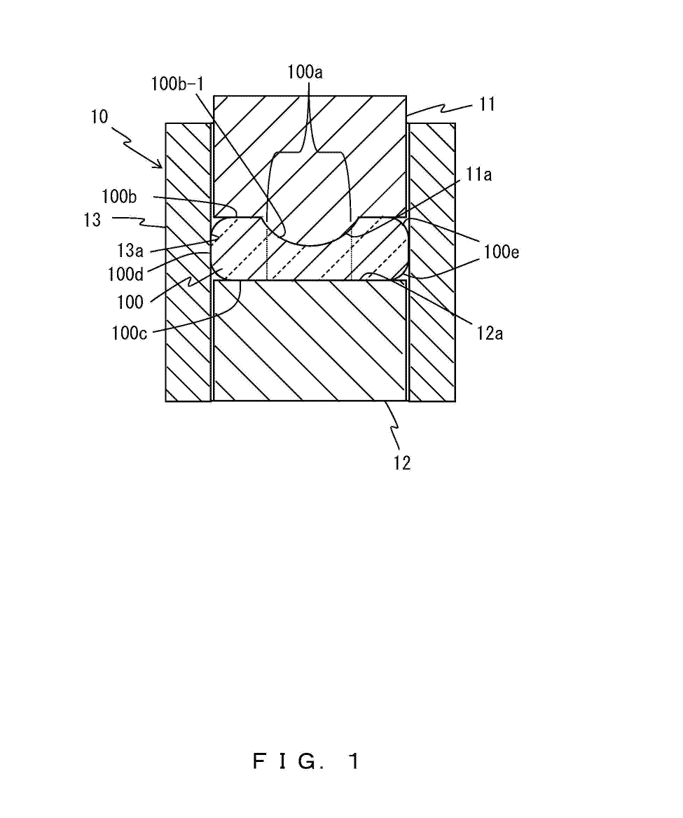

FIG. 1 is a sectional view illustrating a molding state of an optical element 100 according to a first embodiment of the present invention.

A mold set 10 illustrated in FIG. 1 includes an upper die 11, a lower die 12, and a drum die 13.

The upper die 11 has an approximately cylindrical shape, and a convex molding surface 11a is formed on a bottom surface.

The lower die 12 has an approximately cylindrical shape, and a plane molding surface 12a is formed on an upper surface.

The upper die 11 and the lower die 12 are an example of a pair of molding dies, and the shapes above are examples.

The drum die 13 has a cylindrical shape, and is located around the upper die 11 and the lower die 12. An inner peripheral molding surface 13a is formed on an inner periphery of the drum die 13.

The upper die 11 is pressed in a lower direction by not-illustrated pressurizing means so as to slide within the drum die 13 and pressurize the optical element 100.

The optical element 100 is obtained by being pressurized and molded via the mold set 10 (for example, the upper die 11) in a state in which a molding material is heated and softened due to heat conduction, for example, from the mold set 10 (a molding step). The optical element 100 is, for example, a lens. In addition, it is preferable that the molding material be glass.

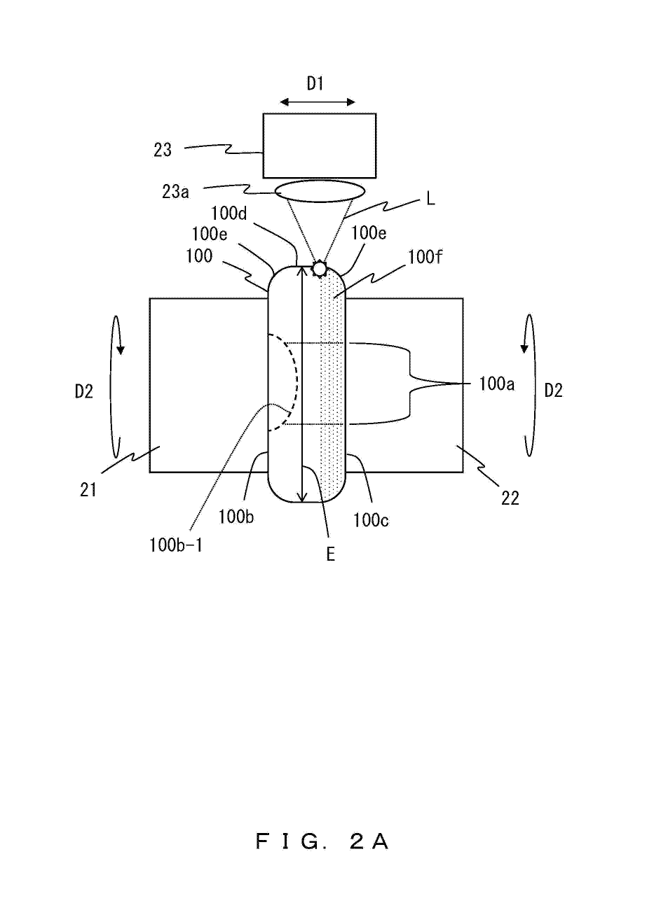

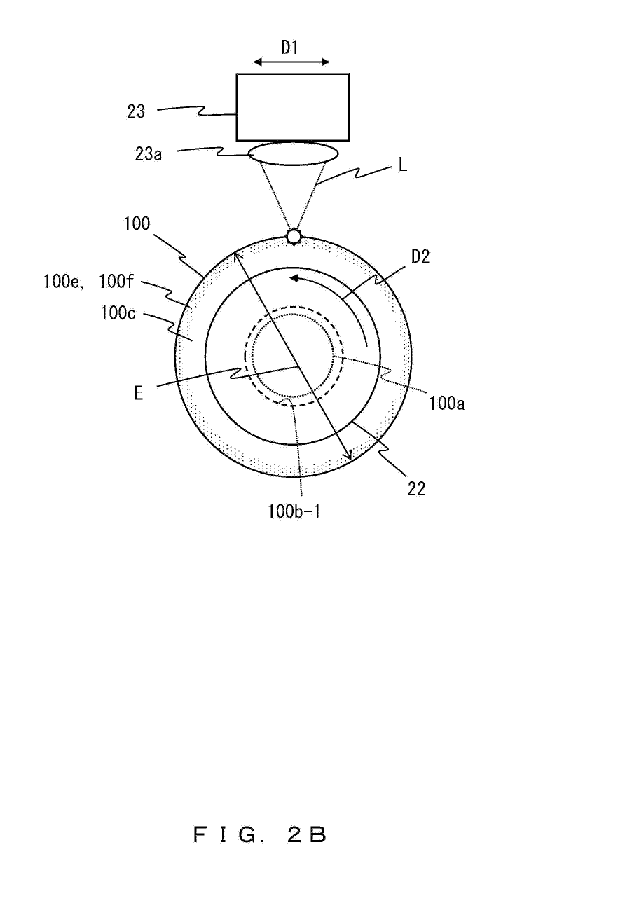

An outer diameter E illustrated in FIGS. 2A and 2B that is formed by molding the optical element 100 is substantially maintained even after a scattering region creating step described later. Accordingly, it is preferable that the outer diameter E of the optical element 100 be formed so as to have a desired dimension in the molding step.

The optical element 100 is cooled down until the optical element 100 has, for example, a temperature that is lower than or equal to a glass transition point before the scattering region creating step described later. Accordingly, the molding step includes a heating step for heating a molding material, a pressurizing step for pressurizing the heated molding material, and a cooling-down step for cooling down the pressurized molding material.

The shapes of the upper die 11, the lower die 12, and the drum die 13 are transferred to the optical element 100 such that an upper molded surface 100b, a lower molded surface 100c, and an outer peripheral molded surface 100d are formed. The shape of the convex molding surface 11a is transferred to the upper molded surface 100b such that a recess 100b-1 is formed in the middle. The optical element 100 has, for example, a disk shape or a cylindrical shape, but the optical element 100 may have another shape such as a polygonal column shape.

An effective diameter 100a of the optical element 100 is a portion that exhibits an optical characteristic (an optical functional surface), and the effective diameter 100a is, for example, a portion that is smaller than the recess 100b-1 of the upper molded surface 100b in a plan view. Details are described later, but according to this embodiment, a scattering region 100f is created in a region outside the recess 100b-1 as an example of the outside of the effective diameter 100a.

In the optical element 100, portions that are not in contact with the upper die 11, the lower die 12, and the drum die 13, namely, a portion that is not in contact with the upper molded surface 100b and the outer peripheral molded surface 100d and a portion that is not in contact with the lower molded surface 100c and the outer peripheral molded surface 100d, become a free surface (a non-molded surface) 100e. The free surface 100e is, for example, a mirror surface.

A scattering region creating step for creating the scattering region 100f outside the effective diameter 100a of the optical element 100 while substantially maintaining the outer diameter E of the optical element 100 that is formed by molding is described next. The outer diameter E is an example of an outside dimension, and examples of another outside dimension include a dimension such as the length or width of one side in the case of an optical element 100 having a polygonal cylindrical shape.

FIGS. 2A and 2B are respectively a front view and a right-hand side view explaining a creation of the scattering region 100f according to the first embodiment.

As illustrated in FIGS. 2A and 2B, the optical element 100 rotates (arrow D2) by the rotation of a pair of rotary holding units 21 and 22 in a state in which the optical element 100 is held by the rotary holding units 21 and 22.

A laser irradiation unit 23 irradiates the optical element 100 via a condenser lens 23a with a laser L. The laser irradiation unit 23 freely moves in a direction of the thickness of the optical element 100 (arrow D1).

According to this embodiment, the laser irradiation unit 23 irradiates the outer peripheral molded surface 100d, which is an outer peripheral surface of the optical element 100, and the free surface 100e, as an example of a portion outside the effective diameter 100a, with the laser L.

Consequently, the scattering region 100f that is a crack or an altered layer is created by laser-marking on the outer peripheral molded surface 100d and the free surface 100e of the optical element 100. The scattering region 100f may be created on only one of the outer peripheral molded surface 100d and the free surface 100e. The scattering region 100f may be created on only a portion of the outer peripheral molded surface 100d and the free surface 100e.

The scattering region 100f is created in a state in which the outer diameter E of the optical element 100 that was formed in the molding step is substantially maintained. A case in which the outer diameter E of the optical element 100 is substantially maintained refers to a case in which the outer diameter E of the optical element 100 does not change so as to exceed, for example, 5 μm, even after the scattering region creating step.

In a case in which a rough surface is formed on the outer peripheral surface of the optical element 100 by grinding, as is conventional, it is difficult to perform processing in such a way that the outer diameter E does not change so as to exceed 5 μm in normal processing, and this results in an increase in costs.

It is preferable that the laser irradiation unit 23 move in a thickness direction (arrow D1) after creating the scattering region 100f on one time around the outer periphery of the optical element 100, and repeat an operation to create the scattering region 100f on another time around of the outer periphery of the optical element 100. The scattering region 100f may be created in a state in which the laser irradiation unit 23 is finely moving in the thickness direction (arrow D1) and the optical element 100 is rotating. The laser irradiation unit 23 may rotate around the optical element 100 without the rotation of the optical element 100.

In a case in which the laser L is an ultra-short pulse laser such as a femtosecond laser, an altered layer is formed in a short time before heat is transferred, and therefore a crack is not generated in the scattering region 100f. However, the scattering region 100f is created outside the effective diameter 100a, and therefore no problems substantially arise in many cases, when a crack, if any, is small.

According to the first embodiment described above, a method for manufacturing the optical element 100 includes a molding step for heating and softening a molding material so as to mold the optical element 100, and a scattering region creating step for creating the scattering region 100f outside the effective diameter 100a of the optical element 100 while substantially maintaining the outer diameter E (an example of an outside dimension) of the optical element 100 formed by molding.

Accordingly, the scattering region 100f can be created without deterioration in accuracy of the outer diameter E, unlike a case in which a rough surface is formed at the time of grinding or molding. In addition, by creating the scattering region 100f, harmful effects due to stray light, such as ghosts or flares, can be reliably prevented by the scattering region 100f, without requiring much time as in a conventional case in which a colored portion is formed within the optical element 100.

Thus, according to this embodiment, harmful effects due to stray light can be prevented simply and reliably while forming the outer diameter E at a high accuracy.

In addition, according to this embodiment, the scattering region 100f is created on the outer peripheral molded surface 100d, which is an outer peripheral surface of the optical element 100, by irradiating the outer peripheral molded surface 100d with the laser L and creating a crack or an altered layer on the outer peripheral molded surface 100d.

Accordingly, the scattering region 100f can be created by irradiating the outer peripheral molded surface 100d with the laser L, and this can easily prevent harmful effects due to stray light.

Further, according to this embodiment, the scattering region 100f is created on the free surface 100e of the optical element 100 by irradiating the free surface 100e with the laser L and forming a crack or an altered layer on the free surface 100e.

In an optical element 100 obtained by only molding without, in particular, centering, it has turned out that internal reflection in the free surface 100e that is, for example, a mirror surface greatly causes harmless effects such as ghosts or flares. Accordingly, harmful effects due to stray light can be prevented simply and reliably by creating the scattering region 100f on the free surface 100e.

### Second Embodiment

This embodiment is different from the first embodiment in that a scattering region 100g is located within the optical element 100, but this embodiment is similar to the first embodiment in the other respects. Accordingly, detailed description is omitted.

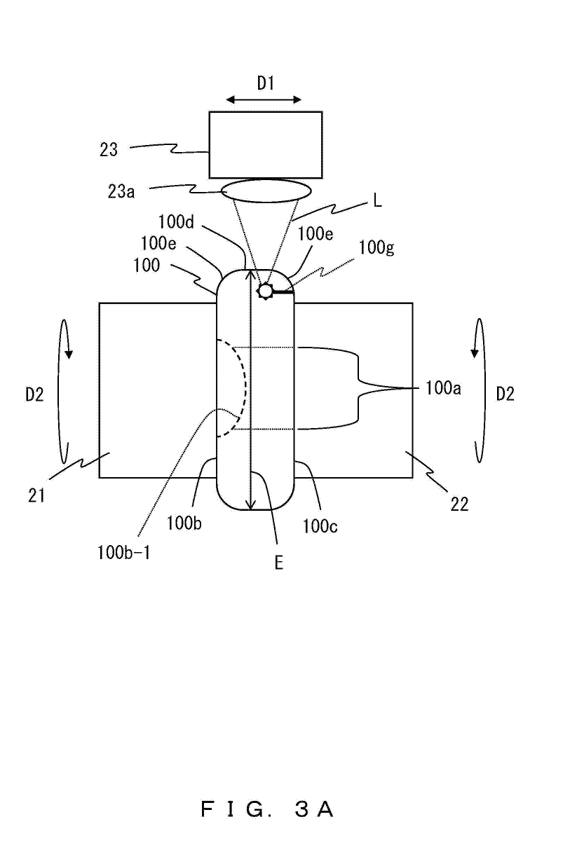

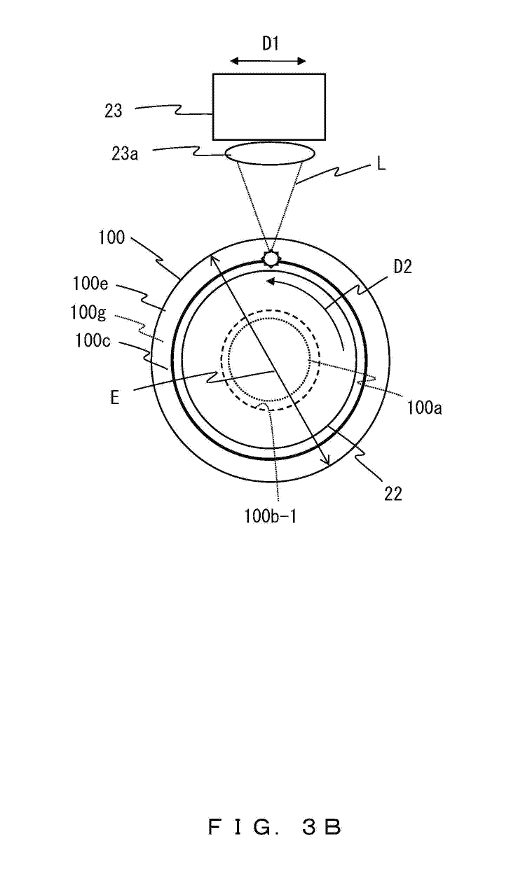

FIGS. 3A and FIG. 3B are respectively a front view and a right-hand side view explaining creation of the scattering region 100g according to the second embodiment.

Also according to this embodiment, the optical element 100 rotates (arrow D2) by the rotation of a pair of rotary holding units 21 and 22 in a state in which the optical element 100 is held by the rotary holding units 21 and 22, as illustrated in FIGS. 3A and 3B. In addition, also according to this embodiment, the laser irradiation unit 23 freely moves in a direction of the thickness of the optical element 100 (arrow D1).

According to this embodiment, the laser irradiation unit 23 irradiates an internal portion outside the effective diameter 100a of the optical element 100 with the laser L. Consequently, the scattering region 100g that is a crack or an altered layer is created in the internal portion of the optical element 100.

The scattering region 100g is created in the internal portion of the optical element 100, and therefore the outer diameter E is maintained (substantially maintained) without changing from an outer diameter E that was formed in the molding step.

Also according to this embodiment, it is preferable that the laser irradiation unit 23 move in a thickness direction (arrow D1) after creating the scattering region 100g on one time around an outer periphery of the optical element 100, and repeat an operation to create the scattering region 100g on another time around the outer periphery of the optical element 100. Consequently, the scattering region 100g is created in a cylindrical shape within the optical element 100.

When the scattering region 100g that is a crack is created over the upper molded surface 100b and the lower molded surface 100c of the optical element 100, the optical element 100 is likely to be missing or cracked. Accordingly, it is preferable that both ends of the scattering region 100g be located so as to be spaced apart from the upper molded surface 100b and the lower molded surface 100c in such a way that both ends are not exposed.

It is also preferable that the scattering region 100g within the optical element 100 be created between an incident side of light to the optical element 100 and the free surface 100e in such a way that it is difficult for stray light to reach the free surface 100e.

In addition, the laser irradiation unit 23 may apply the laser L in the thickness direction (arrow D1) from a side of the upper molded surface 100b or a side of the lower molded surface 100c of the optical element 100. In this case, unless the scattering region 100g is created from a back to front of the thickness direction (arrow D1), a previously created scattering region 100g prevents another scattering region 100g from being created.

Also according to the second embedment described above, a method for manufacturing the optical element 100 includes a molding step for heating and softening a molding material so as to mold the optical element 100, and a scattering region creating step for creating the scattering region 100g outside the effective diameter 100a of the optical element 100 while substantially maintaining the outer diameter E (an example of an outside dimension) of the optical element 100 formed by molding. Accordingly, harmful effects due to stray light can be prevented simply and reliably while forming the outer diameter E at a high accuracy.

In addition, according to this embodiment, the scattering region 100g is created within the optical element 100 by irradiating the inside of the optical element 100 with the laser L and forming a crack or an altered layer within the optical element 100.

Therefore, creation of the scattering region 100g does not affect an outer diameter in comparison with a case in which the scattering region 100f is created on an outer peripheral surface such as the outer peripheral molded surface 100d or the free surface 100e according to the first embodiment. Accordingly, stray light can be reliably scattered, for example, by forming a large crack or altered layer.

### Third Embodiment

According to this embodiment, the laser L is applied from an outer peripheral side (a side of the outer peripheral molded surface 100d or a side of the free surface 100e) of the optical element 100 to the inside of the optical element 100. In addition, scattering regions 100h-1, 100h-2, and 100h-3 are discontinuously created by changing the depth of a position in which the scattering region 100h-1, 100h-2, or 100h-3 is formed according to a position in the thickness direction (arrow D1) of the optical element 100. In this respect, this embodiment is different from the first embodiment and the second embodiment, but in the other respects, this embodiment is similar to the first embodiment and the second embodiment. Accordingly, detailed description is omitted.

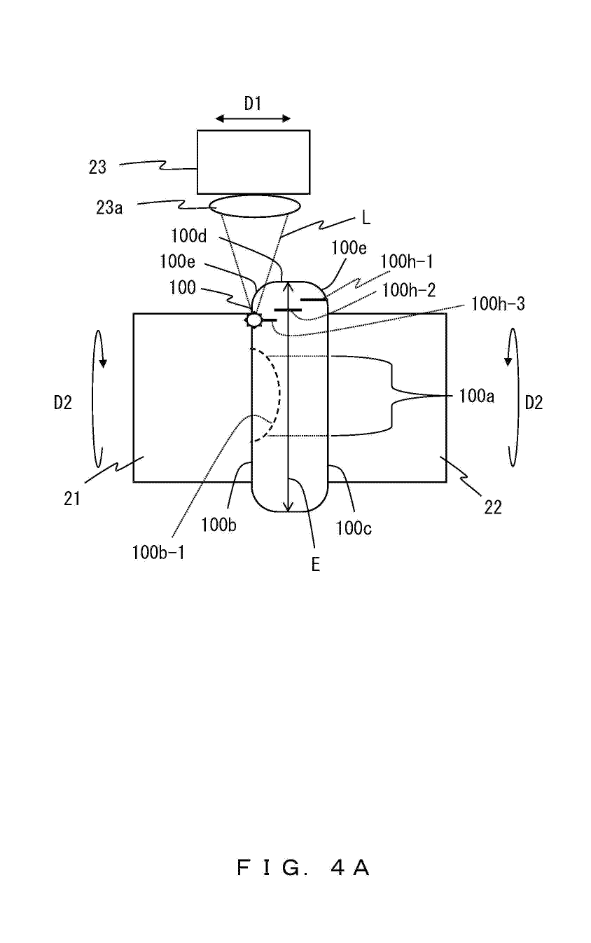

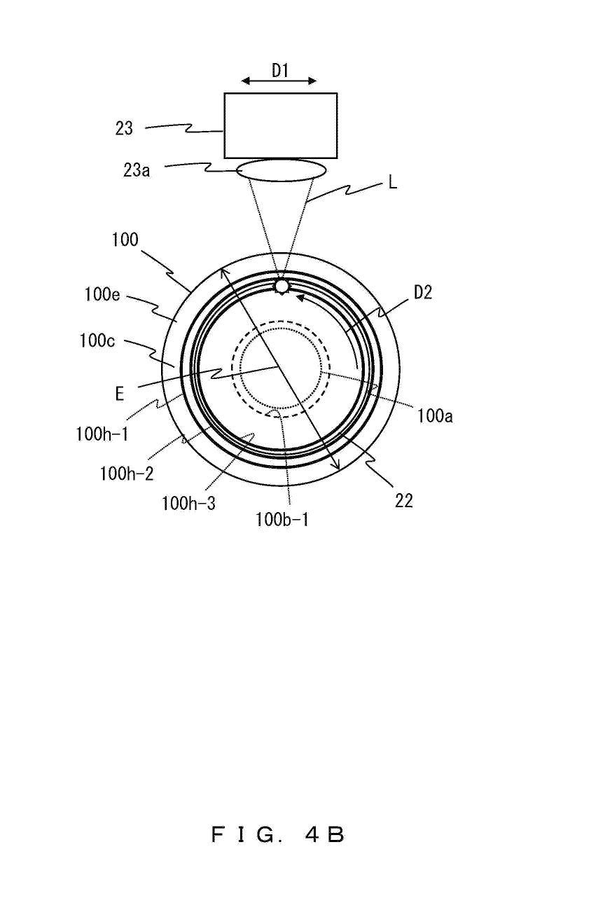

FIG. 4A and FIG. 4B are respectively a front view and a right-hand side view explaining a creation of the scattering regions 100h-1, 100h-2, and 100h-3 according to the third embodiment.

Also according to this embodiment, the optical element 100 rotates (arrow D2) by the rotation of a pair of rotary holding units 21 and 22 in a state in which the optical element 100 is held by the rotary holding units 21 and 22, as illustrated in FIGS. 4A and 4B. In addition, also according to this embodiment, the laser irradiation unit 23 freely moves in the thickness direction (arrow D1) of the optical element 100.

According to this embodiment, the laser irradiation unit 23 applies the laser L from an outer peripheral side (a side of the outer peripheral molded surface 100d or the free surface 100e) of the optical element 100 to the inside of the optical element 100. In addition, the laser irradiation unit 23 changes a focal position of the laser L so as to change the depth of a position in which the scattering region 100h-1, 100h-2, or 100h-3 is formed according to a position in the thickness direction (arrow D1) of the optical element 100. Consequently, the scattering regions 100h-1, 100h-2, and 100h-3, which are cracks or altered layers, are discontinuously created.

Similarly to the second embodiment, the scattering regions 100h-1, 100h-2, and 100h-3 are created inside the optical element 100, and therefore the outer diameter E is maintained (substantially maintained) without changing from an outer diameter E that was formed in a molding step.

Also according to this embodiment, it is preferable that the laser irradiation unit 23 move in the thickness direction (arrow D1) after creating the scattering region 100f on one time around an outer periphery of the optical element 100, and repeat an operation to create the scattering region 100f on another time around the outer periphery of the optical element 100. It is also preferable that the depth of a position in which the scattering region 100h-1, 100h-2, or 100h-3 is formed be changed according to a position in the thickness direction (arrow D1) of the optical element 100, as described above, by changing the focal position of the laser L from the laser irradiation unit 23 once or more.

Also according to the third embodiment described above, a method for manufacturing the optical element 100 includes a molding step for heating and softening a molding material so as to mold the optical element 100, and a scattering region creating step for creating the scattering regions 100h-1, 100h-2, and 100h-3 outside the effective diameter 100a of the optical element 100 while substantially maintaining the outer diameter E (an example of an outside dimension) of the optical element 100 formed by molding. Accordingly, harmful effects due to stray light can be prevented simply and reliably while forming the outer diameter E with a high accuracy.

In addition, according to this embodiment, the laser L is applied from an outer peripheral side (a side of the outer peripheral molded surface 100d or a side of the free surface 100e) of the optical element 100 to the inside of the optical element 100, and the depth of a position in which the scattering region 100h-1, 100h-2, or 100h-3 is formed is changed according to a position in the thickness direction (arrow D1) of the optical element 100. Consequently, scattering region optical elements 100h-1, 100h-2, and 100h-3 are discontinuously created.

Accordingly, similarly to the second embodiment, creation of the scattering region 100g does not affect an outer diameter, and therefore stray light can be reliably scattered, for example, by forming a large crack or altered layer. Further, the optical element 100 can be prevented from being missing or cracked due to continuous scattering regions 100h-1, 100h-2, and 100h-3 inside the optical element 100.

### Fourth Embodiment

This embodiment is different from the first embodiment in that a scattering region 100i is created by etching, but this embodiment is similar to the first embodiment in the other respects. Accordingly, detailed description is omitted.

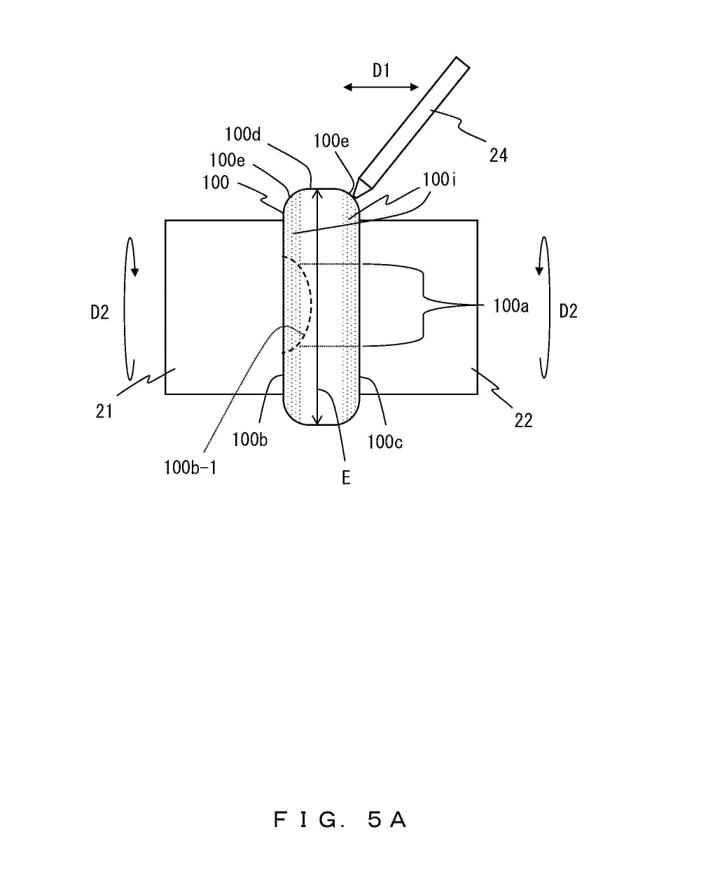

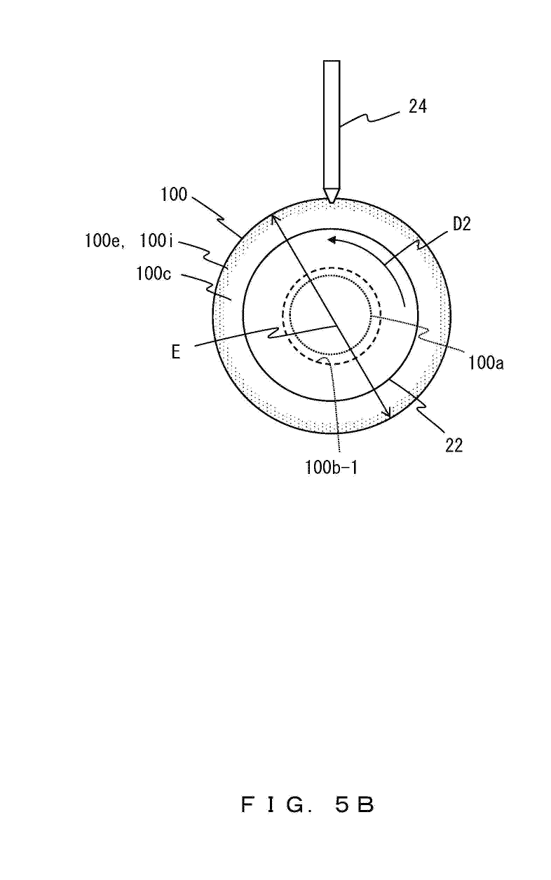

FIG. 5A and FIG. 5B are respectively a front view and a right-hand side view explaining creation of the scattering region i according the fourth embodiment.

Also according to this embodiment, the optical element 100 rotates (arrow D2) by the rotation of a pair of rotary holding units 21 and 22 in a state in which the optical element 100 is held by the rotary holding units 21 and 22, as illustrated in FIGS. 5A and 5B.

In addition, according to this embodiment, as an example, fluoride is applied by using an etching pen 24 such that the scattering region 100i is created on the free surface 100e. The scattering region 100i may also be created on the outer peripheral molded surface 100d, or may be created only on the outer peripheral molded surface 100d, if the scattering region 100i is crated outside the effective diameter 100a. The etching pen 24 may be operated by a person's hand, or may move automatically.

The scattering region 100i is created in a state in which an outer diameter E formed in a molding step of the optical element 100 is substantially maintained. As described in the first embodiment, a case in which the outer diameter E of the optical element 100 is substantially maintained refers to a case in which the outer diameter E of the optical element 100 does not change so as to exceed, for example, 5 μm even after a scattering region creating step.

According to this embodiment, it is preferable that the etching pen 24 be moved in the thickness direction (arrow D1) after creating the scattering region 100i on one time around an outer periphery of the optical element 100, and an operation to create the scattering region 100i be repeated on another time around the outer periphery of the optical element 100.

The scattering region 100i may be created by using another etching method such as a plasma ion beam, instead of chemical wet etching using fluoride. Alternatively, the scattering region 100i may be created without using the laser L according to the first to third embodiments above or etching according to this embodiment, if the outer diameter E of the optical element 100 is substantially maintained.

Also according to the fourth embodiment described above, a method for manufacturing the optical element 100 includes a molding step for heating and softening a molding material so as to mold the optical element 100, and a scattering region creating step for creating the scattering region 100i outside the effective diameter 100a of the optical element 100 while substantially maintaining the outer diameter E (an example of an outside dimension) of the optical element 100 formed by molding. Accordingly, harmful effects due to stray light can be prevented simply and reliably while forming the outer diameter E with a high accuracy.

In addition, according to this embodiment, the scattering region 100i is created by etching, and therefore harmful effects due to stray light can be simply prevented. Further, by creating the scattering region 100i by using another technique other than the laser L, such as etching, a method for creating the scattering region 100i can be determined according to the material of the optical element 100, manufacturing equipment, or the like.

According to the first to fourth embodiments, an outside dimension (the outer diameter E) can be formed with a high accuracy. One feature is that a scattering region is formed while substantially maintaining the outer diameter, and effects according to the first to fourth embodiments above can be achieved, for example, even if a mirror surface that does not have any fine unevenness on an outer peripheral surface is not molded in a molding step. Therefore, it is preferable that an outer diameter in the molding step have a higher accuracy, but the outer diameter is not particularly limited, if the outer diameter is appropriately determined to have a required accuracy.

What is claimed is:

1. An optical element manufacturing method comprising:
heating and softening a molding material so as to mold an optical element; and
creating a scattering region outside an effective diameter of the optical element while substantially maintaining an outside dimension of the optical element formed in molding, wherein
in the creating, the scattering region is created in a region outside the effective diameter of the optical element by irradiating the region outside the effective diameter of the optical element with a laser and forming a crack or an altered layer.

2. The optical element manufacturing method according to claim 1, wherein
in the molding, the optical element is molded by using a pair of molding dies and a drum die having a cylindrical shape, the drum die being located around the pair of molding dies, and
the region outside the effective diameter of the optical element is a free surface of the optical element, the free surface being a portion that is not in contact with the pair of molding dies and the drum die.

3. The optical element manufacturing element according to claim 1, wherein
the region outside the effective diameter of the optical element is an outer peripheral surface of the optical element.
